(19) United States
(12) Patent Application Publication
(10) Pub. No.: US 2006/0234900 A1
(43) Pub. Date: Oct. 19, 2006

(54) Composition and process for preparing a phosphonate and phosphate-free automatic dishwashing powder

(75) Inventors: Keith E. Olson, Apple Valley, MN (US); Howard Kestell, Burnsville, MN (US); Kim R. Smith, Woodbury, MN (US); Michael E. Besse, Golden Valley, MN (US); Brenda Tjelta, St. Paul, MN (US); Kent R. Brittain, Ellsworth, WI (US)

Correspondence Address: MERCHANT & GOULD PC, P.O. BOX 2903, MINNEAPOLIS, MN, 55402-0903, US

(73) Assignee: Ecolab Inc.

(21) Appl. No.: 11/401,626

(22) Filed: Apr. 10, 2006

Related U.S. Application Data
(60) Provisional application No. 60/671,175, filed on Apr. 13, 2005.

(51) Int. Cl. C11D 17/00

(52) U.S. Cl. 510/447; 510/510

(57) ABSTRACT

A method for producing phosphonate in the form of a solid or a gel is provided. The solid can be prepared by neutralizing phosphonic acid as a result of mixing a neutralization composition comprising phosphonic acid and a source of alkalinity to provide phosphonate in a solid form without a step of drying. The gel can be prepared by neutralizing phosphonic acid as a result of mixing a neutralization composition comprising phosphonic acid, a source of alkalinity, and silicate to provide phosphonate in a phosphonate composition in the form of a gel. Methods for producing detergent compositions and detergent compositions are provided.

### CROSS REFERENCE TO RELATED APPLICATIONS

This application claims priority to U.S. Application Ser. No. 60/671,175 that was filed with the United States Patent and Trademark Office on Apr. 13, 2005. The entire disclosure of U.S. application Ser. No. 60/671,175 is incorporated herein by reference.

### FIELD OF THE INVENTION

The invention relates to a method for producing phosphonate, a method for producing a detergent composition, and a detergent composition. In particular, the detergent composition can be provided as substantially phosphate free, and can be provided as a concentrate in the form of a solid or a gel. The detergent composition can be used in various applications including warewashing, laundry washing, clean-in-place (CIP) cleaning, food plant cleaning, dairy plant cleaning, car washing, laundry, presoaking, drying aid, water softening, boiler treatment, and cooling tower treatment.

### BACKGROUND OF THE INVENTION

Phosphates have been commonly used as builders and chelating agents in detergent compositions. Commonly known phosphate salts include sodium and potassium tripolyphosphate, pyrophosphate, polymeric metaphosphate having a degree of polymerization of from about 6 to 21, and orthophosphate. Because phosphates are believed to adversely impact the environment, there has been a continuing effort to decrease phosphate use in detergent compositions and to provide phosphate-free detergents. Exemplary United States patents disclosing alternatives to phosphates in detergent compositions include: U.S. Pat. No. 6,262,008 to Renvall et al; U.S. Pat. No. 5,925,609 to Baillely et al; U.S. Pat. No. 5,786,315 to Sadlowski; U.S. Pat. No. 5,256,327 to Allen et al; and U.S. Pat. No. 4,820,440 to Hemm et al.

Organic phosphonates have been recognized as builders and chelating agents. Because of the high cost of organic phosphonates and the generally advantageous performance of other types of builders and chelating agents, organic phosphonates are often listed as secondary builders or chelating agents. For example, see U.S. Pat. No. 6,528,474 to Artiga Gonzalez et al., U.S. Pat. No. 5,783,539 to Angevaare et al., U.S. Pat. No. 5,773,399 to Baillely et al., and U.S. Pat. No. 6,635,612 to Norman et al.

Automatic dishwashing detergent compositions are often available in the form of solids and/or gels. Solid detergent compositions for use in residential, automatic dishwashers are often provided as powders or tablets. See U.S. Pat. No. 6,303,553 and U.S. Pat. No. 6,191,088. Exemplary gel compositions are disclosed by U.S. Pat. No. 5,384,061 and U.S. Pat. No. 5,232,621.

### SUMMARY OF THE INVENTION

A method for producing phosphonate in the form of a solid is provided according to the invention. The method includes a step of neutralizing phosphonic acid as a result of mixing a neutralization composition comprising phosphonic acid and a source of alkalinity to provide a solid without a step of drying.

A method for producing a phosphonate composition in the form of a gel is provided according to the invention. The method includes a step of neutralizing phosphonic acid as a result of mixing a neutralization composition comprising phosphonic acid, a source of alkalinity, and silicate to provide a gel.

A method for producing a detergent composition in the form of a solid is provided according to the invention. The method includes steps of neutralizing phosphonic acid to provide phosphonate in a solid form without a step of drying, and mixing components to form the detergent composition. The components include at least 10 wt. % of the phosphonate, a source of alkalinity source in an amount sufficient to provide a use composition at a 1 wt. % concentration of the detergent composition having a pH of greater than 7.0, and a secondary builder. The composition can be provided so that it contains less than about 0.1 wt. % phosphate.

A method for producing a detergent composition in the form of a gel is provided according to the invention. The method includes steps of neutralizing phosphonic acid as a result of mixing a neutralization composition containing phosphonic acid, a source of alkalinity, and silicate to provide phosphonate in a phosphonate composition provided as a gel, and mixing components to form the detergent composition.

A detergent composition is provided according to the invention. The detergent composition can be provided as a concentrate in the form of a solid or in the form of a gel. The detergent composition can be characterized as being substantially free of phosphate.

### DETAILED DESCRIPTION OF THE INVENTION

A detergent composition can be provided that includes phosphonate as a builder, chelating agent, or sequestering agent. The detergent composition can be provided in the form of a solid or in the form of a gel. When provided in the form of a solid, the detergent composition can be provided as a powder, an agglomerate, a tablet, a pellet, a block, extruded solid, or mixtures thereof. When provided in the form of a gel, the detergent composition can be characterized as a suspension that behaves as an elastic solid or semi-solid rather than as a liquid. The gel can additionally be characterized as a solid dispersed in a liquid. A gel can exhibit a viscosity greater than water and can flow when a pressure is applied.

The detergent composition can be used in various cleaning environments in place of phosphate containing detergent compositions. The detergent composition can be provided, for example, as a warewashing detergent composition, a dishwashing composition, a laundry detergent composition, a clean-in-place (CIP) detergent composition, a food plant cleaning detergent composition, a dairy plant cleaning detergent composition, a car wash detergent composition, a presoak detergent composition, a drying aid composition, a water softening composition, a boiler treatment composition, or a cooling tower composition.

The detergent composition can be provided as substantially phosphate free. When the detergent composition is characterized as substantially phosphate free, this means that the detergent composition contains an amount of phosphate, if any is present, at a level less than about 0.1 wt. % and preferably less than 0.05 wt. %. A substantially phosphate free detergent composition can contain no phosphate. In addition, it should be understood that the characterization of the amount or lack of amount of phosphate in the detergent composition refers to the detergent composition concentrate. It is expected that the detergent composition will be sold as a concentrate that will then be diluted to form a use composition.

The phrase “detergent composition” refers to the detergent composition provided as a concentrate or as a use composition. The term “concentrate” refers to a relatively concentrated form of the detergent composition that can be diluted with a diluent to form a use composition. An exemplary diluent that can be used to dilute the concentrate to form the use composition is water. In general, the use composition refers to the composition that contacts an article to provide a desired action. For example, a warewashing detergent composition that is provided as a use composition can contact ware for cleaning the ware. In addition, the concentrate or the diluted concentrate can be provided as the use composition. For example, the concentrate can be referred to as the use composition when it is applied to an article without dilution. In many situations, it is expected that the concentrate will be diluted to provide a use composition that is then applied to an article.

Phosphates are often used in detergent compositions as builders, chelating agents, and/or sequestering agents. The detergent composition according to the invention can include phosphonates as builders, chelating agents, and/or sequestering agents.

Formation of Phosphonate Component

Phosphonates can be prepared by neutralizing phosphonic acid with a source of alkalinity. In general, the neutralization reaction of phosphonic acid is a reaction that takes place in a neutralization reaction composition that includes phosphonic acid, a source of alkalinity, and water. The neutralization reaction composition refers to the composition wherein phosphonic acid undergoes a neutralization reaction to form phosphonate. The neutralization reaction composition can include components in addition to phosphonic acid, source of alkalinity, and water. The result of the neutralization reaction can be referred to as the phosphonate component or the phosphonate composition. The phosphonate component can include components in addition to phosphonate. For example, the phosphonate component or the phosphonate composition can include unreacted phosphonic acid, source of alkalinity that remains after the neutralization reaction, and water. In addition, the phosphonate component or the phosphonate composition can include other components that may be present in the neutralization reaction composition during the neutralization reaction.

It is expected that water will be present in the neutralization reaction composition even if it is not added as a separate component in view of its presence with other components of the neutralization reaction composition. That is, water can be added as a separate component or not added as a separate component. If water is not added as a separate component, it is expected that water will be present in the neutralization reaction composition because obtaining completely anhydrous phosphonic acid and maintaining anhydrous conditions during the neutralization reaction may be too expensive and/or too difficult to be commercially acceptable. Furthermore, phosphonic acid is commonly available as 60% active phosphonic acid and as 30% active phosphonic acid. The active level refers to the weight percent of phosphonic acid in the composition where the remaining portion of the composition can be water. As a result, water is typically present in commercially available phosphonic acid and, as a result, it is expected using commercially available phosphonic acid will result in water being present in the neutralization reaction. Water can be added as a separate component or not added as a separate component to the neutralization reaction composition depending upon the desired amount of water in the neutralization reaction composition.

The amount of water present during the neutralization reaction can be controlled to avoid a drying step for the removal of water after the neutralization reaction. By controlling the amount of water present in the neutralization reaction composition, a drying step to produce the phosphonate component in a solid form can be avoided. Because of the presence of water at levels of about 40 wt. % and 70 wt. % (in 60% active and 30% active phosphonic acid, respectively) in the phosphonic acid, water can be controlled in the neutralization reaction composition to a level of at least about 5 wt. % based on the weight of the neutralization reaction composition. In addition, the amount of water in the neutralization reaction composition can be less than about 70 wt. % to avoid having to dry the composition after the neutralization reaction to provide a phosphonate composition in a solid form. In order to avoid removing water from phosphonate composition to provide a phosphonate composition in a solid form, the amount of water in the neutralization composition can be controlled to about 5 wt. % to about 70 wt. %. In addition, the amount of water can be about 10 wt. % to about 60 wt. %, and can be about 20 wt. % to about 40 wt. %, based on the weight of the neutralization composition. The neutralization reaction composition refers to the composition that is subjected to the neutralization reaction. The neutralization reaction composition can be referred to more simply as the “neutralization composition.“

The phosphonic acid component that can be used according to the invention includes those phosphonic acids that can react with a source of alkalinity to provide phosphonate. In general, phosphonic acid refers to a molecule that includes at least one phosphonic acid group. Exemplary phosphonic acids that can be used to form phosphonate include amino trimethylene phosphonic acid; hydroxyethylidene-1,1-diphosphonic acid; hexamethylene diamine tetra methylene phosphonic acid; diethylene triamine pentamethylene phosphonic acid; bishexamethylene triamine pentamethylene phosphonic acid; 2-phosphonobutane-1,2,4-tricarboxylic acid; phosphonomethyliminobis[2,1-ethandiyll nitrilobis(methylene)]tetrakis phosphonic acid; 2-hydroxyethyliminobis(methylenephosphonic acid) HOCH₂CH₂N[CH₂PO(OH)₂]₂; or mixtures thereof. Exemplary phosphonic acids are available under the names Dequest 2000, Dequest 2010, Dequest 2054, and Dequest 2090 from Solutia Inc.

Exemplary phosphonates that can be prepared include amino trimethylene phosphonate; hydroxyethylidene 1,1-diphosphonate; hexamethylene diamine tetra methylene phosphonate; diethylene triamine pentamethylene phosphonate; aminotrimethylene phosphonate; bishexamethylene triamine pentamethylene phosphonate; phosphonobutane tricarboxylate; or mixtures thereof.

The source of alkalinity refers to a component that reacts with the phosphonic acid to provide a phosphonate. Exemplary sources of alkalinity include carbonates, bicarbonates, percarbonates, amines, ammonium salts, polymeric alkaline sources, polyamines and copolymers of polyamines, alkaline silicates, borates, perborates, or mixtures thereof. Exemplary carbonates and bicarbonates include sodium carbonate, potassium carbonate, sodium bicarbonate, potassium bicarbonate, and mixtures thereof.

The ratio of the source of alkalinity to the phosphonic acid should be sufficient to neutralize a sufficient amount of the phosphonic acid to provide the desired amount of the phosphonate component. Because the presence of the source of alkalinity may be a desirable component in the detergent composition into which the phosphonate component can be added, an excess amount of the source of alkalinity can be used so that some of the source of alkalinity remains with the phosphonate component and becomes a part of the detergent composition. An excess of the source of alkalinity refers to an amount of the source of alkalinity greater than the amount needed to provide a desired level of neutralization of the phosphonic acid or the desired amount of phosphonate. The molar ratio of the source of alkalinity to the phosphonic acid can be at least about 0.5:1 to provide a desired level of neutralization of the phosphonic acid. In addition, the molar ratio of the source of alkalinity to the phosphonic acid can be less than about 10:1. The molar ratio of the source of alkalinity to the phosphonic acid can be about 1:1 to about 5:1, and can be about 1.5:1 to about 3:1. In the case where sodium carbonate is the source of alkalinity and hydroxyethylidene-1,1-diphosphonic acid is the phosphonic acid component, the molar ratio of sodium carbonate to phosphonic acid can be at least about 0.5:1 and can be less than about 10:1, and can be about 1:1 to about 5: 1, and can be about 1.5: to about 3:1.

Phosphonate can be prepared by mixing the source of alkalinity and the phosphonic acid together for a sufficient time to provide the desired extent of neutralization. The source of alkalinity and the phosphonic acid can be mixed together in any type of mixing apparatus that provides sufficient contact between the source of alkalinity and the phosphonic acid. When the resulting phosphonate is provided in the form of a solid or in the form of a paste, the mixing apparatus can be selected so that it provides desired mixing of a solid or of a paste. An exemplary mixing apparatus that can be used to mix a solid or a paste includes a ribbon blender. The mixing time to achieve a desired level of neutralization can be at least about 120 seconds. It may be advantageous to add the phosphonic acid to the source of alkalinity when the source of alkalinity is provided as the larger component by weight.

The process for producing the phosphonate can be practiced without a step of drying the phosphonate. That is, after forming the phosphonate as a result of the neutralization reaction between the source of alkalinity and the phosphonic acids, the resulting phosphonate component can be provided as a solid form or as a gel form for addition to a detergent composition. The characterization of the phosphonate as a solid form refers to the phosphonate being provided in a non-liquid form at about 25° C. and atmospheric pressure. In general, the solid form can be characterized as not containing free water in an amount that allows the composition to be characterized as a liquid. By providing the phosphonate in the form of a solid, it is expected that the detergent composition can be available as a powder, pellet, tablet, block, or agglomerate. In general, pellets can be characterized as having a size of about 2 grams to about 10 grams, tablets can be characterized as having a size of about 5 grams to about 30 grams, and blocks can be characterized as having a size of greater than about 30 grams and can be greater than about 100 grams. It should be understood that the size characterization is provided to help understand that the solid phosphonate component can be provided in various forms and having various sizes.

The detergent composition can additionally be provided in a packaging material that dissolves in the presence of water. The combination of the detergent composition and the packaging material can be referred to as a packet. Exemplary forms of the solid that can be conveniently provided in a packet include powders, agglomerates, tablets, pellets, and blocks. The detergent composition can be provided as a gel in a packet that dissolves in the presence of water. In cases where the detergent composition in a packet is intended to be used in a dishwasher, the amount of the detergent composition should be sufficiently small so that the packet will fit within the detergent compartment that is typically found in a door of a dishwasher. This can correspond to an amount of the detergent composition in the packet of less than about 30 grams. The amount of the detergent composition in the packet can be provided at less than about 25 grams, less than about 20 grams, or less than about 15 grams.

The characterization of the phosphonate as a gel refers to a suspension that behaves as an elastic solid or semi-solid rather than as a liquid. In general, a gel is neither a solid nor a liquid, and can be characterized as having a measurable viscosity. For example, a gel can be characterized as having a viscosity of at least about 100 centipoise when measured using a rotary viscometer such as a Brookfield RVT viscometer. In addition, a gel can be characterized as having a viscosity of less than about 100,000 centipoise when measured using a rotary viscometer such as a Brookfield RVT viscometer.

The phosphonate composition can be provided as a gel as a result of the presence of silicate in the neutralization reaction composition during the neutralization reaction. In general, silicate can be provided so that it reacts during the neutralization reaction to a sufficient extent to provide the resulting composition as a gel. It is believed that the reaction of the silicate can be referred to as a polymerization reaction.

The amount and type of silicate can be selected to provide the phosphonate component as a gel as a result of the neutralization reaction. Exemplary silicates that can be used include sodium silicates, potassium silicates, or mixtures of sodium silicates and potassium silicates. Exemplary sodium silicates that can be used are available under the names STIXSO RR™, Clear ™, E™, O™, K™, M™, STAR™, RU™, D™, C™, STARSO™, and B-W™ from The PQ Corporation. Exemplary potassium silicates that can be used include KASIL 1™, KASIL 33™, and KASIL 6™ available from The PQ Corporation. When it is desirable to provide the phosphonate composition in the form of a gel, the silicate can be provided in the neutralization reaction composition in an amount sufficient to provide the phosphonate composition as a gel. By way of example, the phosphonate reaction composition can include at least about 2 wt. % silicate, and can include at least about 3 wt. % phosphonate. The amount of silicate in the neutralization reaction composition can be controlled based on cost and the desirability of including other components in the composition. Although silicate can be characterized as a form of alkalinity, it is believed that there are less expensive options for adding alkalinity than using silicate. Accordingly, the amount of silicate in the composition can be controlled so that other components such as a non-silicate source of alkalinity can be included in the composition. The amount of silicate in the composition can be provided in an amount sufficient to provide the phosphonate reaction composition as a gel and in an amount sufficient to allow for the incorporation of other desired components in the composition. The amount of silicate in the composition can be provided at a level of less than about 15 wt. %.

Silicates generally have a tendency to polymerize at a pH below about 10.7. Accordingly, as the neutralization reaction composition achieves a pH of less than about 10.7, it is expected that the silicate begins to polymerize. It is believed that this polymerization of the silicate is one factor that causes the phosphonate component to achieve a gel form.

An advantage of providing the phosphonate as a gel as a result of the use of a silicate is the ability to avoid the use of conventional thickening agents in the detergent composition. Non-silicate thickening agents are often used in formulating automatic dishwashing machine detergent compositions as gels, and it is believed that certain non-silicate thickening agents may have a detrimental effect on cleaning. Exemplary thickening agents that can be excluded from the detergent composition according to the invention include polymer thickening agents and clay thickening agents. Exemplary polymer thickening agents that can be excluded include polycarboxylate thickening agents such as those available under the name POLYGEL from B.F. Goodrich. Additional polymer thickening agents that can be excluded from the detergent composition according to the invention include acrylic polymers such as those available under the names CARBOPOL 614, CARBOPOL 617, CARBOPOL 672, CARBOPOL 674, CARBOPOL 940, CARBOPOL 941, and CARBOPOL 943 from B.F. Goodrich; polyacrylate polymers such as those available under the names SOKALAN CP45 from BASF and ACRYSOL 45ND from Rohm & Haas; polyglycol ethers such as dialkyl polyglycol ethers available under the name DAPRAL T210 and DAPRAL T212 from Akzo Chemicals. Exemplary clays that are often used as thickeners that can be excluded from the detergent composition according to the invention include bentonite such as that available under the name Bentone EW, montmorillonite such as that available under the names Thixogel #1 and Gelwhite GP from Georgia Kaolin Company; natural clays such as attapulgite such as that available under the names ATTAGEL 40, ATTAGEL 50, and ATTAGEL 150; artificial clays such as that available under the name Laponite from Southern Clay Products, Inc.; synthetic hectorite available under the name SKS-21 from Hoechst; synthetic samponite available under the name SKS-20 Hoechst. It should be understood that such non-silicate thickening agents can be excluded from the phosphonate component and from the detergent composition that includes the phosphonate component. Exemplary non-silicate thickening agents used to form gel detergent compositions are disclosed, for example, in U.S. Pat. No. 5,384,061 to Wise and U.S. Pat. No. 5,232,621 to Dixit et al.

The reference to excluding non-silicate thickening agents refers to either completely excluding non-silicate thickening agents or excluding an amount of non-silicate thickening agent that allows the composition to form a gel. That is, if non-silicate thickening agent is included in the composition, it can be included in amounts below its thickening effective amount. When the detergent composition is provided as excluding a non-silicate thickening agent, the detergent composition can be characterized as substantially free of non-silicate thickening agent. By way of example, a detergent composition that is substantially free of non-silicate thickening agent can exclude polymer thickening agents in an amount greater than 0.5 wt. % and clay thickening agents in an amount greater than about 2 wt. %, based on the weight of the detergent composition concentrate. Preferably, the detergent composition contains zero amount of non-silicate thickening agent. 5 The phosphonate component can be included in the detergent composition in an amount sufficient to provide the desired level of builder, chelating agent, or sequestering agent properties desired for the detergent composition. A detergent composition concentrate can include at least about 3 wt. % phosphonate based on a 100% active level. A solid detergent composition can include about 9 wt. % to about 48 wt. % phosphonate, about 12 wt. % to about 36 wt. % phosphonate, or about 18 wt. % to about 30 wt. % phosphonate. A gel detergent composition can include about 3 wt. % to about 24 wt. % phosphonate, about 6 wt. % to about 21 wt. % phosphonate, or about 9 wt. % to about 15 wt. % phosphonate.

Detergent Composition

The detergent composition can include the phosphonate component as a builder, chelating agent, or sequestering agent, and can include one or more of other components commonly found in detergent compositions including secondary builders, alkalinity sources, surfactants, silicates, stabilizers, dispersants, enzymes, corrosion inhibitors, or aesthetic agents. It should be understood that the secondary builder (or builders), alkalinity sources, surfactants, silicates, stabilizers, dispersants, enzymes, corrosion inhibitors, and aesthetic agents are optional components and can be, individually or collectively, excluded from the detergent composition.

Secondary Builders

While the phosphonate component prepared according to the invention can be used in a detergent composition as a builder, chelating agent, or sequestering agent, additional builders, chelating agents, or sequestering agents can be used in the detergent composition and those components can be referred to as secondary builders. Exemplary secondary builders include: polycarboxy amine derivatives such as ethylenediaminetetraacetic acid (EDTA) or its salts or diethylenetriaminepentaacetic acid (DTPA) or its salts or hydroxy-containing derivatives of these compounds, N-hydroxyethyliminodiacetic acid, nitrilotriacetic acid (NTA), N-hydroxyethyl-ethylenediaminetriacetic acid (HEDTA); aluminosilicates; hydroxyacids; carboxylates such as monocarboxylates, dicarboxylates, tricarboxylates, and polycarboxylates; aluminosilicates; alkylamines such as ethylenediamine, ethylenetriamine, and derivatives of ethylenediamine and ethylenetriamine; nitriloacetates and their derivatives; or mixtures thereof.

The secondary builder can be present at a level such that a use solution of the detergent in 20 grain water hardness does not lead to the formation of precipitate. In the case of a solid detergent composition concentrate, the secondary builder, if present at all, can be provided in an amount of at least about 0.05 wt. % and can be provided up to about 6 wt. %. In addition, the secondary builder can be provided at about 0.5 wt. % to about 4 wt. %, or about 1 wt. % to about 2 wt. %. In the case of a gel detergent composition concentrate, the secondary builder, if present at all, can be provided in an amount of at least about 0.5 wt. % and can be provided in an amount up to about 12 wt. %. In addition, the secondary builder can be provided in an amount of about 1 wt. % to about 8 wt. %, or about 2 wt. % to about 6 wt. %. It should be understood that these weight percentages are based upon an active level of 100%. It should be understood that an active level of 100% refers to a calculation based upon the non-water components of the composition.

Water conditioning polymers can be used as a form of secondary builder. Exemplary water conditioning polymers include polycarboxylates. Exemplary polycarboxylates that can be used as secondary builders and/or water conditioning polymers include those having pendant carboxylate (—CO₂⁻) groups and include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like. For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein. The concentrate can include the water conditioning polymer, if present at all, in an amount of between about 0.1 wt. % and about 5 wt. %, or between about 0.2 wt. % and about 2 wt. % based on an active level of 100% for the composition.

Alkaline Sources

The detergent composition according to the invention can include an effective amount of one or more alkaline sources to enhance cleaning and soil removal performance of the detergent composition. It should be understood that the alkaline source may be provided as part of the phosphonate component. That is, when the phosphonate is formed from a composition that includes more of the source of alkalinity than necessary to neutralize the phosphonic acid, it is expected that there may be some remaining source of alkalinity accompanying the phosphonate component, and the remaining source of alkalinity may become a part of the detergent composition. In general, an effective amount of one or more alkaline sources should be considered as an amount that provides a use composition having a pH of at least about 8. In general, a use composition for determining pH can be considered a detergent composition containing 0.23 wt. % solids, wherein the term “solids” refers to the non-water component of the use composition. The value of 0.23 wt. % is selected for evaluating pH on the basis of 15 grams of detergent composition (solid) combined with 6,500 milliliter of water which is the volume of a typical sump in a dishwasher. In general, it is expected that the pH of the use composition can be at least about 8 to provide desired cleaning. In the case of a dishwashing composition, the composition can be provided so that the use composition has a pH of less than about 11 because it is expected that a pH of greater than about 11 may result in etching of glass. Furthermore, in the event the composition includes pH sensitive components such as enzymes, the detergent composition can be selected to provide a use composition having a pH of about 8 to about 9.5. When the detergent composition is provided for various other types of cleaning such as laundry cleaning, the pH may be provided at levels that can be considered mildly alkaline or at levels that can be considered caustic. In general, when the use composition of a detergent composition has a pH of between 8 and about 10, it can be considered mildly alkaline. When the use composition of a detergent composition has a pH that is greater than about 10 or greater than about 12, the use composition can be considered caustic.

The detergent composition can include a metal carbonate and/or an alkali metal hydroxide as an alkaline source. Exemplary metal carbonates that can be used include, for example, sodium or potassium carbonate, sodium or potassium bicarbonate, sesquicarbonate, and mixtures thereof. Exemplary alkali metal hydroxides that can be used include, for example, sodium or potassium hydroxide. An alkali metal hydroxide may be added to the composition in the form of solid beads, dissolved in an aqueous solution, or a combination thereof. Alkali metal hydroxides are commercially available as a solid in the form of prilled solids or beads having a mix of particle sizes ranging from about 12-100 U.S. mesh, or as an aqueous solution, as for example, as a 50 wt. % and a 73 wt. % solution.

The detergent composition concentrate can include a sufficient amount of the alkaline source to provide the use composition with a pH of at least about 8. The amount of the alkaline source in the detergent composition concentrate can vary depending upon the particular alkaline source selected. The detergent composition can include at least about 2 wt. % of the source of alkalinity. In the case of a solid detergent concentrate, the source of alkalinity can be provided in an amount of about 10 wt. % to about 80 wt. %, about 20 wt. % to about 70 wt. %, or about 50 wt. % to about 65 wt. %. In the case of the gel detergent composition, the source of alkalinity can be present in an amount of about 2 wt. % to about 18 wt. %, about 5 wt. % to about 14 wt. %, or about 7 wt. % to about 9 wt. %. These ranges of the source of alkalinity in the solid detergent concentration and the gel detergent concentration do not reflect the amount of silicate that may be present in the concentrate. In the case of the gel detergent composition, the amount of silicate can be provided in an amount sufficient to provide the concentrate in the form of a gel. In the case of the solid detergent composition, it is expected that the silicate, if present at all, can be present to provide metal protectant properties. In addition, it should be understood that silicate can be provided in the gel detergent composition and the solid detergent composition to provide alkalinity.

It is expected that the detergent composition may provide a use composition that is useful at pH levels below about 8. In such compositions, an alkaline source may be omitted, and additional pH adjusting agents may be used to provide the use composition with the desired pH. Accordingly, it should be understood that the source of alkalinity can be characterized as an optional component and need not be included in the concentrate in an amount sufficient to provide a use composition exhibiting alkalinity.

Cleaning Agent

The detergent composition can include at least one cleaning agent comprising a surfactant or surfactant system. A variety of surfactants can be used in a detergent composition, such as anionic, nonionic, cationic, and zwitterionic surfactants. It should be understood that surfactants are an optional component of the detergent composition and can be excluded from the concentrate.

Exemplary surfactants that can be used are commercially available from a number of sources. For a discussion of surfactants, see Kirk-Othmer, Encyclopedia of Chemical Technology, Third Edition, volume 8, pages 900-912. When the detergent composition includes a cleaning agent, the cleaning agent can be provided in an amount effective to provide a desired level of cleaning.

Anionic surfactants useful in the detergent composition include, for example, carboxylates such as alkylcarboxylates (carboxylic acid salts) and polyalkoxycarboxylates, alcohol ethoxylate carboxylates, nonylphenol ethoxylate carboxylates, and the like; sulfonates such as alkylsulfonates, alkylbenzenesulfonates, alkylarylsulfonates, sulfonated fatty acid esters, and the like; sulfates such as sulfated alcohols, sulfated alcohol ethoxylates, sulfated alkylphenols, alkylsulfates, sulfosuccinates, alkylether sulfates, and the like; and phosphate esters such as alkylphosphate esters, and the like. Exemplary anionic surfactants include sodium alkylarylsulfonate, alpha-olefinsulfonate, and fatty alcohol sulfates.

Nonionic surfactants useful in the detergent composition include, for example, those having a polyalkylene oxide polymer as a portion of the surfactant molecule. Such nonionic surfactants include, for example, chlorine-, benzyl-, methyl-, ethyl-, propyl-, butyl- and other like alkyl-capped polyethylene glycol ethers of fatty alcohols; polyalkylene oxide free nonionics such as alkyl polyglycosides; sorbitan and sucrose esters and their ethoxylates; alkoxylated ethylene diamine; alcohol alkoxylates such as alcohol ethoxylate propoxylates, alcohol propoxylates, alcohol propoxylate ethoxylate propoxylates, alcohol ethoxylate butoxylates, and the like; ethoxylated alcohols such as nonylphenol ethoxylate; polyoxyethylene glycol ethers and the like; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and polyalkylene oxide block copolymers including an ethylene oxide/propylene oxide block copolymer such as those commercially available under the trademark PLURONIC® (BASF-Wyandotte), and the like; and other like nonionic compounds. Silicone surfactants such as the TEGOPREN® B8852 can also be used.

Cationic surfactants that can be used in the detergent composition include amines such as primary, secondary and tertiary monoamines with C₁8 alkyl or alkenyl chains, ethoxylated alkylamines, alkoxylates of ethylenediamine, imidazoles such as a 1-(2-hydroxyethyl)-2-imidazoline, a 2-alkyl-1-(2-hydroxyethyl)-2-imidazoline, and the like; and quaternary ammonium salts, as for example, alkylquaternary ammonium chloride surfactants such as n-alkyl(C₁₂-C₁₈)dimethylbenzyl ammonium chloride, n-tetradecyldimethylbenzylammonium chloride monohydrate, a naphthylene-substituted quaternary ammonium chloride such as dimethyl-1-naphthylmethylammonium chloride, and the like. The cationic surfactant can be used to provide sanitizing properties.

Zwitterionic surfactants that can be used in the detergent composition include betaines, imidazolines, and propinates. When the detergent composition is intended to be used in an automatic dishwashing or warewashing machine, the surfactants selected, if any surfactant is used, can be those that provide an acceptable level of foaming when used inside a dishwashing or warewashing machine. It should be understood that detergent compositions for use in automatic dishwashing or warewashing machines are generally considered to be low-foaming compositions.

The surfactant can be selected to provide low foaming properties if low foaming properties are desired. One would understand that low foaming surfactants that provide the desired level of detersive activity are advantageous in an environment such as a dishwashing machine where the presence of large amounts of foaming can be problematic. In addition to selecting low foaming surfactants, one would understand that defoaming agents can be utilized to reduce the generation of foam. In addition, the surfactants can be selected to provide foaming for use in those applications where foaming is desired. Exemplary applications where foaming may be desired include vehicle washing and environmental cleaning.

It should be understood that a surfactant is not a required component of the detergent composition and can be excluded from the detergent composition. In general, when a surfactant is included in the solid detergent composition, the surfactant can be included in an amount of at least about 0.5 wt. %. The solid detergent composition can include a surfactant in an amount of about 0.5 wt. % to about 15 wt. %, about 0.8 wt. % to about 5 wt. %, or about 1 wt. % to about 3 wt. %. In the case of a gel, the surfactant can be included in an amount of about 0.5 wt. % to about 15 wt. %, about 1 wt. % to about 10 wt. %, or about 2 wt. % to about 5 wt. %.

Other Additives

The detergent composition can include other additives such as bleaching agents, fillers, defoaming agents, hardening agents or solubility modifiers, defoamers, anti-redeposition agents, stabilizers, dispersants, enzymes, metal protecting agents, aesthetic enhancing agents (i.e., dye, fragrance), and the like. Adjuvants and other additive ingredients will vary according to the type of composition being manufactured. It should be understood that these additives are optional and need not be included in the cleaning composition. When they are included, they can be included in an amount that provides for the effectiveness of the particular type of component.

Bleaching agents for use in a cleaning compositions for lightening or whitening a substrate include bleaching compounds capable of liberating an active halogen species, such as Cl₂, Br₂, —OCl⁻ and/or —OBr⁻, under conditions typically encountered during the cleansing process. Suitable bleaching agents for use in the present cleaning compositions include, for example, chlorine-containing compounds such as a chlorine, a hypochlorite, chloramine. Exemplary halogen-releasing compounds include the alkali metal dichloroisocyanurates, chlorinated trisodium phosphate, the alkali metal hypochlorites, monochloramine and dichloramine, and the like. Encapsulated chlorine sources may also be used to enhance the stability of the chlorine source in the composition (see, for example, U.S. Pat. Nos. 4,618,914 and 4,830,773, the disclosure of which is incorporated by reference herein). A bleaching agent may also be a peroxygen or active oxygen source such as hydrogen peroxide, perborates, sodium carbonate peroxyhydrate, phosphate peroxyhydrates, potassium permonosulfate, and sodium perborate mono and tetrahydrate, with and without activators such as tetraacetylethylene diamine, and the like. The composition can include an effective amount of a bleaching agent. When the concentrate includes a bleaching agent, it can be included in an amount of about 0.1 wt. % to about 60 wt. %, about 1 wt. % to about 20 wt. %, about 3 wt. % to about 8 wt. %, or about 3 wt. % to about 6wt. %.

The composition can include detergent fillers. A detergent filler does not perform as a cleaning agent per se, but cooperates with the cleaning agent to enhance the overall cleaning capacity of the composition. Examples of detergent fillers that can be used include sodium sulfate, sodium chloride, starch, sugars, C₁-C₁₀ alkylene glycols such as propylene glycol, and the like. When the concentrate includes a detergent filler, it can be included an amount of about 1 wt. % to about 20 wt. %, or between about 3 wt. % to about 15 wt. %.

A defoaming agent for reducing the stability of foam can be included in the composition to reduce foaming. When the concentrate includes a defoaming agent, the defoaming agent can be provided in an amount of between about 0.01 wt. % and about 3 wt. %.

Examples of defoaming agents that can be used in the composition includes ethylene oxide/propylene block copolymers such as those available under the name Pluranic N-3, silicone compounds such as silica dispersed in polydimethylsiloxane, polydimethylsiloxane, and functionalized polydimethylsiloxane such as those available under the name TEGOPPREN® B9952, fatty amides, hydrocarbon waxes, fatty acids, fatty esters, fatty alcohols, fatty acid soaps, ethoxylates, mineral oils and polyethylene glycol esters. A discussion of defoaming agents may be found, for example, in U.S. Pat. No. 3,048,548 to Martin et al., U.S. Pat. No. 3,334,147 to Brunelle et al., and U.S. Pat. No. 3,442,242 to Rue et al., the disclosures of which are incorporated by reference herein.

The detergent composition can include hardening agents or solubility modifiers. A hardening agent is a component that contributes to the uniform solidification of the composition. The hardening agent can be compatible with the cleaning agent and other active components of the composition, and is capable of providing an effective amount of hardness to the composition.

The amount of hardening agent included in the composition can vary according to the type of cleaning composition being prepared, the ingredients of the composition, the intended use of the composition, the quantity of dispensing solution applied to the solid composition over time during use, the temperature of the dispensing solution, the hardness of the dispensing solution, the physical size of the solid composition, the concentration of other ingredients, the concentration of the cleaning agent in the composition and other factors.

Exemplary hardening agents include, for example, an amide such as stearic monoethanolamide, lauric diethanolamide, and stearic diethanolamide, available commercially from Stepan Chemical under the trademark NINOL™, and from Scher Chemical Company under the trademark SCHERCO-MID™. Alkyl amides provide varying degrees of hardness and solubility when combined with cationizing surfactants. Generally, the C₁₆ to C₁₈ straight chain aliphatic alkyl amides provide a higher degree of insolubility with a higher degree of hardness. For a further discussion of alkyl amide hardening agents, see U.S. Pat. No. 5,019,346 to Richter, the disclosure of which is incorporated herein by reference.

Another hardening agent is a polyethylene glycol (PEG) or propylene glycol compound for use in a cleaning composition comprising a nonionic surfactant cleaning agent, such as a nonyl phenol ethoxylate, a linear alkyl alcohol ethoxylate, an ethylene oxide/propylene oxide block copolymers such as the surfactants available under the trademark PLURONIC™ from BASF-Wyandotte. The solidification rate of cleaning compositions comprising a polyethylene glycol hardening agent made according to the invention will vary, at least in part, according to the amount and the molecular weight of the polyethylene glycol added to the composition.

Polyethylene glycol compounds useful according to the invention include, for example, solid polyethylene glycols of the general formula H(OCH₂—CH₂)ₙOH, where n is greater than 15, more preferably about 30-1700. Solid polyethylene glycols that are useful are marketed under the trademark Carbowax™, and are commercially available from Union Carbide. Preferably, the polyethylene glycol is a solid in the form of a free-flowing powder or flakes, having a molecular weight of about 1000-100,000, preferably about 3000-8000. Suitable polyethylene glycol compounds useful according to the invention include, for example, PEG 900, PEG 1000, PEG 1500, PEG 4000, PEG 6000, PEG 8000 among others, with PEG 8000 being preferred.

The hardening agent can be a hydratable substance such as an anhydrous sodium carbonate, anhydrous sodium sulfate, or combination thereof. The hydratable hardening agent can be used in an alkaline cleaning composition which includes ingredients such as a condensed phosphate hardness sequestering agent and an alkaline builder salt, wherein the amount of caustic builders is about 5-15 wt. %, as disclosed, for example, in U.S. Pat. Nos. 4,595,520 and 4,680,134 to Heile et al., the disclosures of which are incorporated by reference herein. A hydratable hardening agent, according to the invention, is capable of hydrating to bind free water present in a liquid detergent emulsion to the extent that the liquid emulsion becomes hardened or solidified to a homogenous solid. The amount of a hydratable substance included in a detergent composition can vary according to the percentage of water present in the liquid emulsion as well as the hydration capacity of the other ingredients. The composition can comprise about 10-60 wt. % or about 20-40 wt. % of a hydratable hardening agent.

Other hardening agents that may be used in a cleaning composition processed according to the invention include, for example, urea, also known as carbamide, starches that have been made water-soluble through an acid or alkaline treatment process, and various inorganics that impart solidifying properties to a heated liquid matrix upon cooling.

The composition can include an anti-redeposition agent for facilitating sustained suspension of soils in a cleaning solution and preventing the removed soils from being redeposited onto the substrate being cleaned. Examples of suitable anti-redeposition agents include fatty acid amides, fluorocarbon surfactants, styrene maleic anhydride copolymers, and cellulosic derivatives such as hydroxyethyl cellulose, hydroxypropyl cellulose, and the like. When the concentrate includes an anti-redeposition agent, the anti-redeposition agent can be included in an amount of between about 0.5 wt. % to about 10 wt. %, or between about 1 wt. % and about 5 wt. %.

Stabilizing agents that can be used include primary aliphatic amines, betaines, borate, calcium ions, sodium citrate, citric acid, sodium formate, glycerine, maleonic acid, organic diacids, polyols, propylene glycol, and mixtures thereof. The concentrate need not include a stabilizing agent, but when the concentrate includes a stabilizing agent, it can be included in an amount that provides the desired level of stability of the concentrate. Exemplary ranges of the stabilizing agent include about 0.25 wt. % to about 20 wt. %, about 0.5 wt. % to about 15 wt. %, or about 2 wt. % to about 10 wt. %.

Dispersants that can be used in the composition include maleic acid/olefin copolymers, polyacrylic acid, and mixtures thereof. The concentrate need not include a dispersant, but when a dispersant is included it can be included in an amount that provides the desired dispersant properties. Exemplary ranges of the dispersant in the concentrate can be between about 0.25 wt. % to about 20 wt. %, about 0.5 wt. % to about 15 wt. %, or about 2 wt. % to about 9 wt. %.

Enzymes that can be included in the composition include those enzymes that aid in the removal of starch and/or protein stains. Exemplary types of enzymes include proteases, alpha-amylases, and mixtures thereof. Exemplary proteases that can be used include those derived from Bacillus licheniformis, Bacillus lenus, Bacillus alcalophilus, and Bacillus amyloliquefacins. Exemplary alpha-amylases include Bacillus subtilis, Bacillus amyloliquefaceins and Bacillus licheniformis. The concentrate need not include an enzyme. When the concentrate includes an enzyme, it can be included in an amount that provides the desired enzymatic activity when the detergent composition is provided as a use composition. Exemplary ranges of the enzyme in the concentrate include about 0.25 wt. % to about 15 wt. %, about 0.5 wt. % to about 10 wt. %, or about 1 wt. % to about 5 wt. %.

The detergent composition can include metal protecting agents to help reduce corrosion or etching of metals. Silicates can be included in the detergent composition to provide for metal protection such as aluminum protection. Silicates are additionally known to provide alkalinity and additionally function as anti-redeposition agents. Exemplary silicates include sodium silicate, potassium silicate, sodium polysilicate, and potassium polysilicate. The detergent composition can be provided without silicates, but when silicates are included, they can be included in amounts that provide for desired metal protection. The concentrate can include silicates in amounts of at least about 1 wt. %, at least about 5 wt. %, at least about 10 wt. %, and at least about 15 wt. %. In addition, in order to provide sufficient room for other components in the concentrate, the silicate component can be provided at a level of less than about 35 wt. %, less than about 25 wt. %, less than about 20 wt. %, and less than about 15 wt. %. In the case of the gel detergent composition, the silicate can be included to provide a thickening effect. The gel detergent composition can include the silicate in an amount of about 2 wt. % to about 15 wt. %, about 4 wt. % to about 10 wt. %, or about 6 wt. % to about 8 wt. %.

Various dyes, fragrances, and other aesthetic enhancing agents can be included in the detergent composition. Dyes may be included to alter the appearance of the composition, as for example, Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keystone Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like. Fragrances or perfumes that may be included in the compositions include, for example, terpenoids such as citronellol, aldehydes such as amyl cinnamaldehyde, a jasmine such as C1S-jasmine or jasmal, vanillin, and the like.

The components used to form the concentrate can include an aqueous medium such as water as an aid in processing. It is expected that the aqueous medium will help provide the components with a desired viscosity for processing. In addition, it is expected that the aqueous medium may help in the solidification process when is desired to form the concentrate as a solid. When the concentrate is provided as a solid, it can be provided in the form of a block or pellet. It is expected that blocks will have a size of at least about 5 grams, and can include a size of greater than about 50 grams.

When the components that are processed to form the concentrate are processed into a block, the components can be processed by extrusion techniques or casting techniques. In general, when the components are processed by extrusion techniques, it is believed that the composition can include a relatively smaller amount of water as an aid for processing compared with the casting techniques. In general, when preparing the solid by extrusion, it is expected that the composition can contain between about 2 wt. % and about 10 wt. % water. When preparing the solid by casting, it is expected that the amount of water can be provided in an amount of between about 20 wt. % and about 40 wt. %.

When the detergent composition is used in the presence of glass, a glass corrosion inhibitor can be included in the detergent composition in an amount sufficient to provide a use composition that exhibits a rate of corrosion of glass that is less than the rate of corrosion of glass for an otherwise identical use composition except for the absence of the corrosion inhibitor. Exemplary corrosion inhibitors that can be used in the detergent composition include those corrosion inhibitors disclosed in U.S. application Ser. No. 10/612,474 that was filed with the United States Patent and Trademark Office on Jul. 2, 2003 and U.S. application Ser. No. 10/877,049 that was filed with the United States Patent and Trademark Office on Jun. 25, 2004.

The detergent composition concentrate can be prepared by mixing various components together. Exemplary ranges for components of the solid detergent composition are identified in Table 1 where the components are identified on a weight percent basis. Although multiple components may, in fact, be combined when they are added to the detergent composition, they are broken apart in Table 1. For example, the phosphonate component or phosphonate composition that is added to form the detergent composition may include phosphonate, alkalinity, and water. In Table 1, the components are broken out and separately identified. Exemplary ranges for various components of the gel detergent composition are similarly identified in Table 2 on a weight percent basis.

TABLE 1
Solid Detergent Composition on Weight Percent Basis

| | | |
|---|---|---|
| wt. % | wt. % | wt. % |

Components

| | | | |
|---|---|---|---|
| Phosphonate | 9-48 | 12-36 | 18-30 |
| Source of alkalinity | 10-80 | 20-70 | 50-65 |

Optional Components

| | | | |
|---|---|---|---|
| Silicate | 5-30 | 8-20 | 10-15 |
| Secondary Builder | 0.5-6 | 0.5-4 | 1-2 |
| Dispersant | 0.5-1.9 | 0.1-1.0 | 0.2-0.5 |
| Enzyme | 0.5-10 | 1-6 | 2-4 |
| Surfactant | 0.5-10 | 0.8-5 | 1-3 |
| Fragrance | 0.005-4 | 0.01-2 | 0.1-1 |
| Dye | 0.005-4 | 0.01-2 | 0.1-1 |
| Water | 6-32 | 8-24 | 12-20 |

TABLE 2
Gel Detergent Composition on a Weight Percent Basis

| | | |
|---|---|---|
| wt. % | wt. % | wt. % |

Components

| | | | |
|---|---|---|---|
| Phosphonate | 3-24 | 6-21 | 9-15 |
| Source of alkalinity | 2-18 | 5-14 | 7-9 |
| Silicate | 2-14 | 4-10 | 6-8 |

Optional Components

| | | | |
|---|---|---|---|
| Secondary Builder | 0.5-12 | 1-8 | 2-6 |
| Stabilizer | 1-20 | 2-15 | 5-10 |
| Dispersant | 0.5-19 | 2-14 | 4-9 |
| Enzyme | 0.5-15 | 1-10 | 2-5 |
| Corrosion Inhibitor | 0.2-6 | 0.4-4 | 0.8-2 |
| Surfactant | 0.5-15 | 1-10 | 2-5 |
| Fragrance | 0.005-15 | 0.01-10 | 0.1-5 |
| Dye | 0.005-4 | 0.01-2 | 0.1-1 |
| Water | 25-80 | 30-70 | 40-60 |

Packaging Material

The detergent composition concentrate can be provided in a packaging material that can be characterized as water-soluble or water-dispersible. Preferred packaging used to contain the compositions is manufactured from a material which is biodegradable and/or water-soluble during use. Such packaging is useful for providing controlled release and dispensing of the contained cleaning composition. Biodegradable materials useful for packaging the compositions of the invention include, for example, water-soluble polymeric films comprising polyvinyl alcohol, as disclosed for example in U.S. Pat. No. 4,474,976 to Yang,; U.S. Pat. No. 4,692,494 to Sonenstein; U.S. Pat. No. 4,608,187 to Chang; U.S. Pat. No. 4,416,793 to Haq; U.S. Pat. No. 4,348,293 to Clarke; U.S. Pat. No. 4,289,815 to Lee; and U.S. Pat. No. 3,695,989 to Albert, the disclosures of which are incorporated by reference herein.

The above specification provides a basis for understanding the broad metes and bounds of the invention. The following examples and test data provide an understanding of certain specific embodiments of the invention. The examples are not meant to limit the scope of the invention that has been set forth in the foregoing description. Variations within the concepts of the invention are apparent to those skilled in the art.

### EXAMPLE 1

### Neutralization of Hydroxyethylidene 1,1-diphosphonic Acid with Sodium Carbonate

Approximately 1000 grams of sodium carbonate was added to a ribbon blender. About 800 grams of 60% active 1-hydroxyethylidene-1,1 diphosphonic acid (Dequest 2010 available from Solutia) was added to the sodium carbonate, neutralizing the phosphonic acid and converting it to the phosphonate in dry powder form. The weight ratio of sodium carbonate to phosphonic acid was about 2.1:1. The resulting phosphonate could be used as a dry powder, and did not require a step of drying to remove water.

### EXAMPLE 2

### Neutralization of Hydroxyethylidene 1,1-diphosphonic Acid with Sodium Carbonate

Approximately 800 grams of sodium carbonate was added to a ribbon blender, and about 500 grams of 1-hydroxyethylidene-1,1 diphosphonic acid was added to the sodium carbonate to neutralize the phosphonic acid and convert it to phosphonate in dry powder form. The weight ratio of carbonate to phosphonic acid was 2.6:1.

### EXAMPLE 3

### Preparation of a Zero Phosphate Containing Automatic Dishwashing Detergent using Sodium Phosphonate as the Primary Builder

A detergent composition was prepared by dry blending the components identified in Table 3. The phosphonate identified in Table 3 is the phosphonate prepared in Example 1. The detergent composition contains no phosphate. The pH of a 0.23 wt. % use composition of the detergent composition is 10.2, and the cleaning performance was comparable to that of another detergent containing sodium tripolyphosphate (STPP) as the primary builder as disclosed in U.S. application Ser. No. 10/612,474 that was filed with the United States Patent and Trademark Office on Jul. 2, 2003, and U.S. application Ser. No. 10/877,049 that was filed with the United States Patent and Trademark Office on Jun. 25, 2004. The water used to form the use composition can be characterized as soft water (approximately 3 grain water).

TABLE 3
Detergent Composition

| Component | wt % |
|---|---|
| alcohol alkoxylate^{A} | 2.40% |
| EO/PO copolymer^{B} | 0.20% |
| pentasodium diethylenetriamine | 4.90% |
| pentaacetate^{C} | |
| polycarboxylate, sodium salt^{D} | 0.30% |
| sodium percarbonate | 10.00% |
| sodium polysilicate^{E} | 12.00% |
| phosphonate (2.1:1 carbonate:acid) | 62.16% |
| maleic/olefin copolymer^{F} | 0.30% |
| zinc chloride, anhydrous | 2.55% |
| aluminum sulfate | 1.89% |
| enzyme^{G} | 2.8% |
| fragrance | 0.50% |
| | 100.00% |

^{A}Plurafac SLF-18 from BASF.
^{B}D-500 from Huntsman Chemical.
^{C}Hampex-80 is a 40% active solution available from Hampshire Chemical.
^{D}Acusol 445N is a sodium salt of polyacrylic acid from Rohm & Haas.
^{E}Britesil H-20 from Philadelphia Quartz.
^{F}Acusol 460ND is a maleic acid/olefin copolymer from Rohm & Haas.
^{G}Purastar, Purafect, and Properase from Genecor.

### EXAMPLE 4

### Preparation of an Automatic Dishwashing Detergent Composition using Sodium Phosphonate as the Primary Builder

A detergent composition was prepared by dry blending the components identified in Table 4. The phosphonate used was the product from Example 2. The components identified in Table 4 are similar to the components identified in Table 3. The pH of a 0.23 wt. % use composition of the resulting detergent composition is 9.94, and the cleaning performance was comparable to that of a detergent composition containing STPP as the primary builder as disclosed in U.S. application Ser. No. 10/612,474 that was filed with the United States Patent and Trademark Office on Jul. 2, 2003 and U.S. application Ser. No. 10/877,049 that was filed with the United States Patent and Trademark Office on Jun. 25, 2004. The water used to form the use composition can be characterized as soft water (approximately 3 grain water).

TABLE 4
Detergent Composition

| Component | wt % |
|---|---|
| alcohol alkoxylate | 2.33% |
| EO/PO copolymer | 1.46% |
| pentasodium diethylenetriamine | 4.76% |
| pentaacetate | |
| polycarboxylate, sodium salt | 0.49% |
| sodium percarbonate | 23.34% |
| sodium polysilicate | 11.67% |
| phosphonate premix (2.1:1 carbonate:acid) | 39.37% |
| maleic/olefin copolymer | 0.29% |
| zinc chloride, anhydrous | 2.48% |
| aluminum sulfate | 1.84% |
| enzyme | 1.36% |
| protease enzyme | 1.36% |
| fragrance | 0.49% |
| sodium bicarbonate | 8.76% |
| | 100.00% |

### EXAMPLE 5

### Dry Neutralization Followed by Extrusion

This example shows the preparation of an extruded detergent composition. Although the detergent composition includes sodium tripolyphosphate, it is expected that the process can be carried out without the incorporation of the phosphate component.

A phosphonate component was prepared by mixing 84.5 wt. % sodium carbonate and 15.48 wt. % 1-hydroxyethylidene-1,1-diphosphonic acid. The sodium carbonate was added to a ribbon blender and the 1-hydroxyethylidene-1,1-diphosphonic acid was added thereto to form the carbonate premix.

Powder Premix A was prepared having the composition shown in Table 5.

TABLE 5
Powder Premix A

| Component | wt. % |
|---|---|
| sodium tripolyphosphate premix | 24.658 |
| sodium carbonate premix | 54.027 |
| alkylaryl polyether premix | 2.715 |
| sodium polysilicate | 4.329 |
| polycarboxylate, sodium salt | 4.000 |
| Water | 4.000 |

The components of Powder Premix A were combined by first adding the sodium tripolyphosphate premix to a ribbon blender, adding the sodium carbonate premix, slowly adding the alkylaryl polyether premix, adding sodium polysilicate, adding polycarboxylate, sodium salt, and adding water, and mixing.

Powder Premix B was prepared having the composition shown in Table 6.

TABLE 6
Powder Premix B

| Component | wt. % |
|---|---|
| sodium tripolyphosphate | 24.658 |
| sodium carbonate premix | 54.027 |
| alkylaryl polyether premix | 2.715 |
| sodium polysilicate | 4.329 |
| polycarboxylate, sodium salt | 4.000 |
| D-Glucitol | 2.000 |

Powder Premix B was prepared by adding sodium tripolyphosphate premix to a ribbon blender, adding the sodium carbonate premix, slowly adding alkylaryl polyether premix, adding the sodium polysilicate, adding the polycarboxylate, sodium salt, and adding the D-Glucitol and mixing.

Powder Premix C was prepared having the composition identified in Table 7.

TABLE 7
Powder Premix C

| Component | wt. % |
|---|---|
| sodium carbonate | 45.661 |
| 1-dyroxyethylidene-1,1- | 8.366 |
| diphosphonic acid | |
| polycarboxylate, sodium salt | 4.000 |
| sodium tripolyphosphate premix | 24.658 |
| alkylaryl polyether premix | 2.715 |
| sodium polysilicate | 4.329 |

Powder Premix C was prepared by adding sodium carbonate to a ribbon blender, slowly adding 1-hydroxyethylidene-1,1-diphosphonic acid, slowly adding polycarboxylate, sodium salt, adding sodium tripolyphosphate premix, adding alkylaryl polyether premix, and adding sodium polysilicate, and mixing.

Powder Premix D was prepared having the composition shown in Table 8.

TABLE 8
Powder Premix D

| Component | wt. % |
|---|---|
| sodium carbonate | 45.661 |
| sodium tripolyphosphate | 24.658 |
| premix | |
| amino tri (methylene | 14.137 |
| phosphonic acid) | |
| alkylaryl polyether premix | 2.715 |
| sodium polysilicate | 4.329 |
| dispersant | 4.000 |

Powder Premix D was prepared by adding sodium carbonate to a ribbon blender, adding sodium tripolyphosphate premix, adding amino tri (methylene phosphonic acid), adding alkylaryl polyether premix, adding sodium polysilicate, slowly adding polycarboxylate, sodium salt, and mixing.

These powder premixes were then fed to an extruder and made into a solid product.

### EXAMPLE 6

### Example of a Stable Gel Containing 0% Phosphate

Premix A was prepared having the composition identified in Table 9. The 1-hydroxyethylidene-1,1-diphosphonic acid was added to the water in a mixing vessel.

TABLE 9
Premix A

| Component | wt. % |
|---|---|
| DI Water | 21.23 |
| 1-hydroxyethylidene1,1-diphosphonic acid | 15.50 |

Premix B was prepared having the composition shown in Table 10. Premix B was prepared by adding potassium hydroxide to a mixing vessel, adding polyacrylic acid, sodium salt, adding potassium silicate, and adding fatty alcohol alkoxylate.

TABLE 10
Premix B

| Component | wt. % |
|---|---|
| Potassium hydroxide, 45% | 10.37 |
| Polyacrylic acid, sodium salt | 7.00 |
| Potassium silicate | 20.50 |
| Fatty alcohol alkoxylate | 2.00 |

Premix C was prepared having the composition shown in Table 11. Premix C was prepared by adding potassium carbonate to a ribbon blender, adding zinc chloride, adding sodium aluminate, adding sodium tetraborate decahydrate, and adding boric acid.

TABLE 11
Premix C

| Component | wt. % |
|---|---|
| Potassium carbonate | 5.40 |
| Zinc chloride | 2.00 |
| Sodium aluminate | 2.00 |
| Sodium tetraborate decahydrate | 7.00 |
| Boric acid | 3.00 |

Premix D was prepared having the composition shown in Table 12. Premix D was prepared by adding alpha amylase to a mixing vessel, adding subtilisin, and adding fragrance.

TABLE 12
Premix D

| Component | wt. % |
|---|---|
| Alpha amylase | 1.50 |
| Subtilisin | 1.50 |
| Fragrance | 1.00 |

Stable gel was prepared by adding Premix B to Premix A under high shear, and adding Premix C under high shear. The composition was cooled to less than 80° F. and Premix D was added.

This gel has a stable viscosity of about 60,000 cPs (RVT #5 @5 rpm). There is very minimal syneresis after 8 months at ambient temperature. The thickening mechanism is believed to be a result of the reaction of the potassium silicate at a reduced pH.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for producing phosphonate for use in a cleaning composition, the method comprising:
(a) neutralizing phosphonic acid as a result of mixing a neutralization composition comprising the phosphonic acid and a source of alkalinity to provide phosphonate in a solid phosphonate composition without a step of drying.

2. A method for producing phosphonate according to claim 1, wherein the phosphonate comprises at least one of amino trimethylene phosphonate; hydroxyethylidene 1,1-diphosphonate; hexamethylene diamine tetra methylene phosphonate; diethylene triamine pentamethylene phosphonate; aminotrimethylene phosphonate; bishexamethylene triamine pentamethylene phosphonate; phosphonobutane tricarboxylate; or mixtures thereof.

3. A method for producing phosphonate according to claim 1, wherein the phosphonic acid comprises at least one of amino trimethylene phosphonic acid; hydroxyethylidene-1,1-diphosphonic acid; hexamethylene diamine tetra methylene phosphonic acid; diethylene triamine pentamethylene phosphonic acid; bishexamethylene triamine pentamethylene phosphonic acid; 2-phosphonobutane-1,2,4-tricarboxylic acid; phosphonomethyliminobis[2,1-ethandiyll nitrilobis(methylene)]tetrakis phosphonic acid; 2-hydroxyethyliminobis(methylenephosphonic acid) HOCH₂CH₂N[CH₂PO(OH)₂]₂; or mixtures thereof.

4. A method for producing phosphonate according to claim 1, wherein the source of alkalinity comprises at least one of carbonate, bicarbonate, percarbonate, amine, ammonium salt, polymeric alkaline source, polyamine, copolymer of polyamine, alkaline silicate, borate, perborate, or mixtures thereof.

5. A method for producing phosphonate according to claim 1, wherein the molar ratio of the source of alkalinity to the phosphonic acid is about 10:1 to about 0.5:1.

6. A method for producing phosphonate according to claim 1, wherein the molar ratio of the source of alkalinity to the phosphonic acid is about 5:1 to about 1:1.

7. A method for producing phosphonate according to claim 1, wherein the molar ratio of the source of alkalinity to the phosphonic acid is about 3:1 to about 1.5:1.

8. A method for producing phosphonate according to claim 1, wherein the neutralization composition comprises water in an amount of about 5 wt. % to about 70 wt. %.

9. A method for producing phosphonate according to claim 1, wherein the composition comprises water in an amount of about 10 wt. % and about 60 wt. %.

10. A method for producing phosphonate according to claim 1, wherein the composition comprises water in an amount of about 20 wt. % and about 40 wt. %.

11. A method for producing phosphonate for use in a cleaning composition, the method comprising:
(a) neutralizing phosphonic acid as a result of mixing a neutralization composition comprising the phosphonic acid, a source of alkalinity, and silicate to provide phosphonate in a phosphonate composition provided as a gel.

12. A method for producing phosphonate according to claim 11, wherein the phosphonate comprises at least one of amino trimethylene phosphonate; hydroxyethylidene 1,1-diphosphonate; hexamethylene diamine tetra methylene phosphonate; diethylene triamine pentamethylene phosphonate; aminotrimethylene phosphonate; bishexamethylene triamine pentamethylene phosphonate; phosphonobutane tricarboxylate; or mixtures thereof.

13. A method for producing phosphonate according to claim 11, wherein the phosphonic acid comprises at least one of amino trimethylene phosphonic acid; hydroxyethylidene-1,1-diphosphonic acid; hexamethylene diamine tetra methylene phosphonic acid; diethylene triamine pentamethylene phosphonic acid; bishexamethylene triamine pentamethylene phosphonic acid; 2-phosphonobutane-1,2,4-tricarboxylic acid; phosphonomethyliminobis[2,1-ethandiyll nitrilobis(methylene)]tetrakis phosphonic acid; 2-hydroxyethyliminobis(methylenephosphonic acid) HOCH₂CH₂N[CH₂PO(OH)₂]₂; or mixtures thereof.

14. A method for producing phosphonate according to claim 11, wherein the silicate comprises at least one of sodium silicate, potassium silicate, and mixtures of sodium silicate and potassium silicate.

15. A method for producing phosphonate according to claim 11, wherein the silicate has a tendency to polymerize at a pH below about 10.7.

16. A method for producing phosphonate according to claim 11, wherein the phosphonate composition is substantially free of non-silicate thickening agents.

17. A method for producing phosphonate according to claim 11, wherein the phosphonate composition has a viscosity of at least about 100 centipoise and less than about 100,000 centipoise when measured using a Brookfield RVT viscometer.

18. A method for producing phosphonate according to claim 11, wherein the molar ratio of the source of alkalinity to the phosphonic acid is about 10:1 to about 0.5:1.

19. A method for producing phosphonate according to claim 11, wherein the neutralization composition comprises water in an amount of about 5 wt. % to about 70 wt. %.

20. A method for producing phosphonate according to claim 11, wherein the source of alkalinity comprises at least one of carbonate, bicarbonate, percarbonate, amine, ammonium salt, polymeric alkaline source, polyamine, copolymer of polyamine, borate, perborate, and mixtures thereof.

21. A method for producing a detergent composition, the method comprising:
(a) neutralizing phosphonic acid as a result of mixing a neutralization composition comprising the phosphonic acid and a source of alkalinity to provide phosphonate in a solid form without a step of drying; and
(b) mixing components to form the detergent composition, the components comprising:
(i) at least 10 wt. % of the phosphonate;
(ii) source of alkalinity in an amount sufficient to provide a use composition at a 1 wt. % concentration of the detergent composition having a pH of greater than 7.0; and
(iii) wherein the composition contains less than about 0.1 wt. % phosphate.

22. A method according to claim 21, wherein the phosphonate comprises at least one of amino trimethylene phosphonate; hydroxyethylidene 1,1-diphosphonate; hexamethylene diamine tetra methylene phosphonate; diethylene triamine pentamethylene phosphonate; aminotrimethylene phosphonate; bishexamethylene triamine pentamethylene phosphonate; phosphonobutane tricarboxylate; or mixtures thereof.

23. A method according to claim 21, wherein the phosphonic acid comprises at least one of amino trimethylene phosphonic acid; hydroxyethylidene-1,1-diphosphonic acid; hexamethylene diamine tetra methylene phosphonic acid; diethylene triamine pentamethylene phosphonic acid; bishexamethylene triamine pentamethylene phosphonic acid; 2-phosphonobutane-1,2,4-tricarboxylic acid; phosphonomethyliminobis[2,1-ethandiyll nitrilobis(methylene)]tetrakis phosphonic acid; 2-hydroxyethyliminobis(methylenephosphonic acid) HOCH₂CH₂N[CH₂PO(OH)₂]₂; or mixtures thereof.

24. A method according to claim 20, wherein the phosphonate comprises a polymeric phosphonate.

25. A method according to claim 21, wherein the detergent composition comprises about 10 wt. % to about 90 wt. % of the phosphonate.

26. A method according to claim 21, wherein the detergent composition comprises about 15 wt. % to about 65 wt. % of the phosphonate.

27. A method according to claim 21, wherein the detergent composition comprises about 35 wt. % to about 60 wt. % hydroxyethylidene 1,1-diphosphonate; aminotrimethylene phosphonate; or mixture thereof.

28. A method according to claim 21, wherein the source of alkalinity comprises at least one carbonate, bicarbonate, sulfate, citrate, borate, silicate, percarbonate, perborate, amine, or mixtures thereof.

29. A method according to claim 21, wherein the source of alkalinity comprises polymeric amine.

30. A method according to claim 21, wherein the detergent composition comprises about 10 wt. % to about 70 wt. % of the source of alkalinity.

31. A method according to claim 20, wherein the source of alkalinity comprises an alkaline gas.

32. A method according to claim 31, wherein the alkaline gas comprises at least one of amine, ammonia, and mixture thereof.

33. A method according to claim 21, wherein the detergent composition comprises a secondary builder.

34. A method according to claim 20, wherein the secondary builder comprises at least one of polycarboxyamine derivative; aluminosilicate, hydroxy acid, carboxylate, aluminosilicate, alkylamine, nitriloacetate, or mixtures thereof.

35. A method according to claim 21, wherein the detergent composition further comprises at least one of silicate, bleach, enzyme, surfactant, glass-etch inhibitor, anti-redeposition agent, pH modifier, antimicrobial agent, sheeting agent, flow aid, corrosion inhibitor, defoamer, bleach activator, filler, dye, or fragrance.

36. A method according to claim 21, wherein the detergent composition is provided in the form of a powder, an agglomerate molded solid, or an extruded solid.

37. A method according to claim 21, further comprising:
(a) packaging within a water-soluble or water-dispersible packaging.

38. A method for producing a detergent composition, the method comprising:
(a) neutralizing phosphonic acid as a result of mixing a neutralization composition comprising the phosphonic acid, a source of alkalinity, and silicate to provide phosphonate in a phosphonate composition provided as a gel; and
(b) mixing components to form the detergent composition, the components comprising:
(i) at least 10 wt. % of the phosphonate;
(ii) source of alkalinity in an amount sufficient to provide a use composition at a 1 wt. % concentration of the detergent composition having a pH of greater than 7.0; and
(iii) wherein the composition contains less than about 0.1 wt. % phosphate.

39. A method according to claim 38, wherein the detergent composition is provided in the form of a gel.

40. A method according to claim 38, wherein the composition has a viscosity of about 100 centipoise to about 100,000 centipoise when measured using a rotary viscometer.

41. A method according to claim 38, wherein the detergent composition is substantially free of a non-silicate thickening agent.

42. A method according to claim 38, wherein the detergent composition comprises about 2 wt. % to about 14 wt. % of the silicate.

43. A method according to claim 38, wherein the detergent composition comprises a secondary builder.

44. A solid detergent composition comprising:
(a) at least about 9 wt. % phosphonate;
(b) at least about 10 wt. % source of alkalinity;
(c) at least about 0.5 wt. % surfactant; and
(d) wherein the composition is substantially free of phosphate.

45. A solid detergent composition according to claim 44, wherein the solid is provided in the form of a powder, an agglomerate, a tablet, a pellet, a block, or mixture thereof.

46. A gel detergent composition comprising:
(a) at least about 3 wt. % phosphonate;
(b) at least about 2 wt. % source of alkalinity;
(c) at least about 2 wt. % silicate;
(d) at least about 0.5 wt. % surfactant; and
(e) wherein the composition is substantially free of phosphate.

47. A gel detergent composition according to claim 46, wherein the gel has a viscosity of about 100 centipoise to about 100,000 centipoise when measured using a Brookfield RVT viscometer.

48. A gel detergent composition according to claim 46, wherein the detergent composition contains no greater than 0.5 wt. % non-silicate polymer thickening agent.

49. A gel detergent composition according to claim 46, wherein the detergent composition contains no greater than 2 wt. % clay thickening agent.

50. A gel detergent composition according to claim 46, wherein the composition contains no non-silicate thickening agent.
